(19) United States
(12) Patent Application Publication
(10) Pub. No.: US 2007/0291151 A1
(43) Pub. Date: Dec. 20, 2007

(54) Apparatus and method for showing

(75) Inventor: Zhe Dong, Shenzhen (CN)

Correspondence Address: Clifford J. Mass;Ladas & Parry LLP, 26 West 61 Street, New York, NY, 10023, US

(73) Assignee: HUA WEI TECHNOLOGIES CO., LTD.

(21) Appl. No.: 11/811,352

(22) Filed: Jun. 8, 2007

(30) Foreign Application Priority Data
Jun. 8, 2006 (CN) 200610087328.7

(51) Int. Cl. H04N 5/222

(52) U.S. Cl. 348/333.1

(57) ABSTRACT

A camera device includes an image acquisition unit, an image storage unit, an image display unit adapted to display for projecting images in accordance with image information stored in the image storage unit or directly from the image acquisition unit, a light source unit adapted to provide a light source when the image display unit displaying images; a camera lens adapted to magnify images, and a switch management unit adapted to manage the image display unit, the light source and the camera lens; wherein the images are projected through the camera lens. A method for showing images in a camera device include: obtaining image information via a lens of a camera device, and displaying the image information with illumination of a light source to project images corresponding to the image information through the lens for showing. Further, a mobile phone having a projecting function is provided.

### CROSS-REFERENCE TO RELATED APPLICATIONS

This application is claiming priority of Chinese Application No. 200610087328.7 filed on Jun. 8, 2006, entitled “A Camera device having a Projection Function” which application is incorporated by reference herein in its entirety.

### FIELD OF THE INVENTION

The present invention relates to a camera device, more particularly to a camera device having an additional function.

### BACKGROUND OF THE INVENTION

For conventional consumer electronic device having a functionality of taking photo or recording video, e.g., digital camera and mobile telephone having a camera, etc., images are taken by means of the camera of the device and stored in the device. If the images need to be showed on a big screen, it is necessary to use some additional device. For example, the images are output to a computer and the computer transmits the images to a projector, then the images are projected onto a screen via the projector.

Therefore, it is necessary to take some additional device to show the images in a large screen in conventional consumer electronic device. But the additional device is inconvenient to be carried all the time.

### SUMMARY OF THE INVENTION

An embodiment of the present invention provides a camera device including: an image acquisition unit, an image storage unit, an image display unit, adapted to display for projecting images according to image information stored in the image storage unit or directly from the image acquisition unit, a light source unit, adapted to provide a light source when the image display unit displays the images, a camera lens, adapted to magnify image, and a switch management unit, adapted to manage the image display unit, the light source and the camera lens to cooperatively operating to projecting the image for showing, wherein, the images are projected through the camera lens using the light source and the displaying of the image display unit under the managing of the switch management unit.

An embodiment of the present invention provides a method for showing images in a camera device including: obtaining image information via a lens of a camera device; and displaying the image information with illumination of a light source to project images corresponding to the image information through the lens for showing.

An embodiment of the present invention provides a mobile phone including: an image acquisition unit, adapted to obtaining image information, an image storage unit, adapted to obtain image information, an image display unit, adapted to display for projecting images according to image information stored in the image storage unit or directly from the image acquisition unit, a light source unit, adapted to provide a light source when the image display unit displays the images, a camera lens, adapted to magnify image, and a switch management unit, adapted to manage the image display unit, the light source and the camera lens to cooperatively operating to projecting the image for showing, wherein, the images are projected through the camera lens using the light source and the displaying of the image display unit under the managing of the switch management unit.

One or more embodiments of the present invention has the following advantages: The present invention enables the user to select camera function or projection function under control of the switch management unit by arranging a light source and an image display unit in the camera device; it is possible for the camera device to project large screen image.

When the projection function is selected, the camera lens is used as a projecting lens for projecting image information, with a reverse way compared with the camera function, therefore, no additional projecting lens is needed and thereby the cost is reduced; in addition, the present invention has advantages including compactness, high portability, and easy operation, etc.

### BRIEF DESCRIPTION OF THE DRAWINGS

FIG. 1 is a simplified drawing illustrating a basic structure of the camera device according to an embodiment of the invention;

FIG. 2 is a simplified drawing illustrating a camera device according to an embodiment of the invention;

FIG. 3 is a simplified drawing illustrating another camera device according to an embodiment of the invention.

### DETAILED DESCRIPTION OF THE INVENTION

Detailed description of the invention will be given with reference to the embodiments and the accompanying drawings.

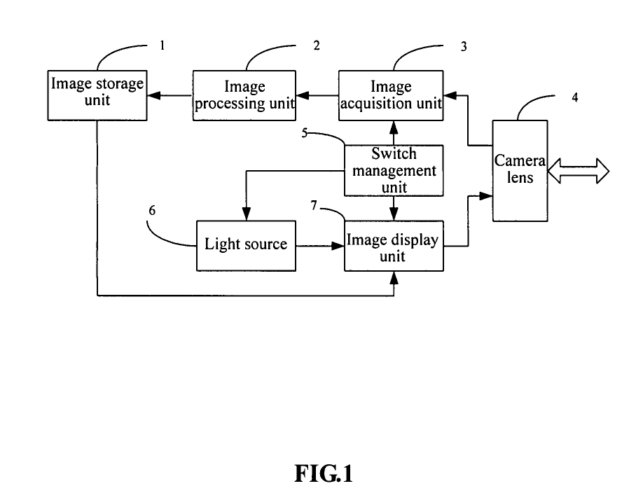

Hereinafter, embodiments of the present invention will be described in detail with reference to FIG. 1 to FIG. 3.

FIG. 1 is a drawing illustrating a basic structure of the camera device having a projection function according to an embodiment of the invention. The camera device includes: a camera lens 4 for collecting image information, an image acquisition unit 3 for obtaining image information via the camera lens 4, an image processing unit 2 for processing the image information, and an image storage unit 1 for storing the processed image information. The camera device further includes: an image display unit 7 for displaying for projecting images corresponding to the image information; a light source 6 for providing light source for showing, and a switch management unit 5 for controlling or managing the obtaining and displaying or projecting for showing of the image. The camera lens 4 is adapted to magnify image when the image information is projected through the camera lens 4.

In the embodiment, the switch management unit 5 is adapted to control the working state of the image acquisition unit 3 and the image display unit 7. The image acquisition unit 3 is adapted to acquire image information via the camera lens 4 under the control of the switch management unit 5. The image information may be converted into digital image signal by an A/D conversion sub-unit in the image processing unit 2, and the digital image signal is compressed by a compression sub-unit and stored in the image storage unit 1. The image display unit 7 is adapted to display the image information read from the image storage unit 1 or directly from the acquisition unit 3, output the image information and project the image through the camera lens 4 and by means of illumination of the light source 6, under the control of the switch management unit 5. So the images in the camera device in the embodiment can be projected onto a large screen for showing without additional device.

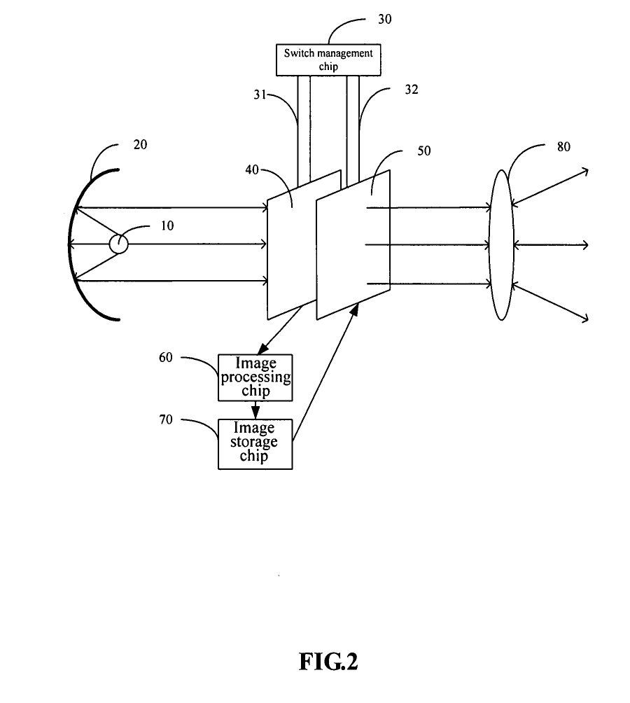

FIG. 2 is a drawing illustrating a camera device according to an embodiment of the invention. The camera device shown in the FIG. 2 includes: a light source 10 for providing a light source, a mirror condenser 20 for collimating and reflecting the light emitted from the light source for providing parallel light, a lens 80 for collecting image information or magnifying image, a switch management chip 30 for controlling or managing, an image acquisition unit 40 for obtaining image information via the lens 80 under the controlling or managing of the switch management chip 30, an image processing chip 60 for processing the image information obtained by the acquisition unit 40, the processing may comprising coding, decoding and analog/digital converting, an image storage chip 70 for storing processed image information, a transmission-type image display unit 50 for displaying images according to the image information stored in the image storage chip 70 or directly from the acquisition unit 40.

The image acquisition unit 40 is coupled to the switch management chip 30 via a link bar 31. Similarly, the image display unit 50 is coupled to the switch management chip 30 via a link bar 32. When there is image information need to be taken into the camera device, the image acquisition unit 40 is enabled, and the transmission-type image display unit 50 is disabled and moved away from the light path by means of link bar 32, under the controlling or managing of switch management chip 30. Accordingly, the image information is acquired by the image acquisition unit 40 via the lens 80. Furthermore, the image information may be processed, e.g., compressed encoding, by the image processing chip 60 and stored in the image storage chip 70.

When the image information stored in the image storage chip 700 or directly from the acquire image acquisition unit 400 needs to be projected for showing, the transmission-type image display unit 50 is enabled, and the image acquisition unit 40 is disabled and moved away from the light path by means of link bar 31. While the light source 10 is turned on, the image information is received by the transmission-type image display unit 50 and displayed thereon. The light emitted from the light source 10 is collimated by the mirror condenser 20 and illuminated on the transmission-type image display unit 50. Therefore, the image is reversed, magnified and projected through the lens 80. In this embodiment, the light path is adjusted by means of link bars 31 and 32, under the control of the switch management chip 30. Those skilled in the art may understand that any other methods can be used to adjust the light path, for example, by means of rotation axis and the like.

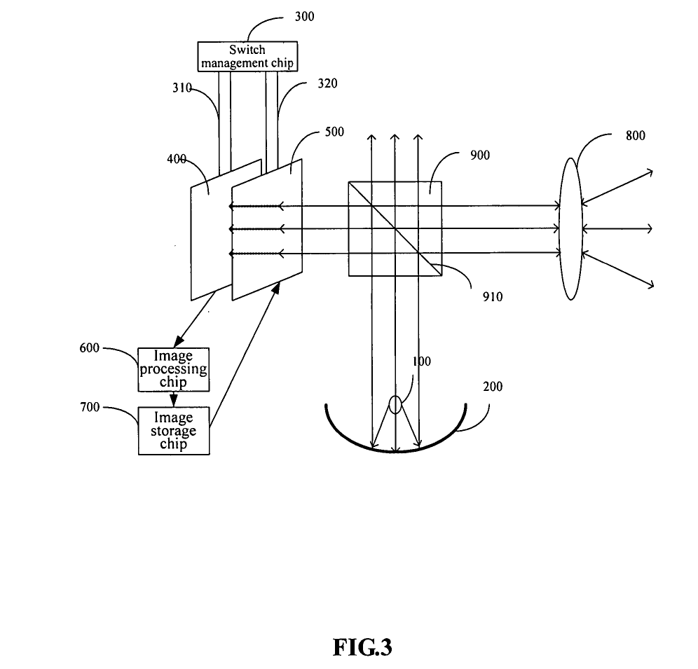

FIG. 3 is a drawing illustrating a camera device according to another embodiment of the invention. The camera device includes a light source 100, a mirror condenser 200, a switch management chip 300, an image acquisition unit 400, a reflection-type image display unit 500, an image processing chip 600, an image storage chip 700, a lens 800, and a cubic polarized beam splitter 900; in which, the image acquisition unit 400 is coupled to the switch management chip 300 via a link bar 310; the image display unit 500 is coupled to the switch management chip 300 via a link bar 320; the cubic polarized beam splitter 900 has a face 910 that reflects S polarized light of incident light and transmits P polarized light of incident light.

Furthermore, a mobile phone may be provided in another embodiment of the present invention. The mobile phone includes a camera device, configured to project image information stored, acquired or received from the network for showing. The camera device may further includes: a camera lens, adapted to magnify image, an image display unit, adapted to display for projecting images according to image information, a light source unit, adapted to provide a light source when the image display unit displays the images, a switch management unit, adapted to manage the image display unit, the light source and the camera lens to cooperatively operating to projecting the image for showing. The images are projected through the camera lens using the light source and the displaying of the image display unit under the managing of the switch management unit. The camera lens may further be adapted to collect image information. The image display unit may be of transmission type or reflection type.

When there is image information need to be taken into the camera device, the image acquisition unit 400 is enabled and the reflection-type image display unit 500 is disabled and moved away from the light path with link bar 320, under the control of the switch management chip 300. Accordingly, image information is acquired by the image acquisition unit 400 via the lens 800 and the cube polarized beam splitter 900. Furthermore, the image information acquired may be processed, e.g., compressed encoding, by the image processing chip 600 and stored in the image storage chip 700.

When the image information stored in the image storage chip 700 or directly from the acquire image acquisition unit 400 need to be projected for showing, the reflection-type image display unit 500 is enabled and the image acquisition unit 400 is disabled, while the light source 100 is turned on, after the light emitted from the light source 100 passing through the mirror condenser 200, a parallel light is formed and illuminated on the cubic polarized beam splitter 900, where the S polarized light is reflected to the image display unit 500, while the P polarized light is transmitted; the light reflected from the image display unit 500 is incident on the cubic polarized beam splitter 900 again; for the incident light reflected from the image display unit 500, the amount of the light transmitting through the cubic polarized beam splitter 900 is depended upon the degree of polarization modulation for P polarized light; the image information carried by the transmitting light is magnified and projected to a screen through the lens 800.

The light source used in above embodiments is usually a cold intensive-light source, so as to reduce the heat generated from the camera device. The camera lens may include Charge Coupled Device (CCD) or Complementary Metal-Oxide Semiconductor (CMOS); in which, CCD is usually used in high-end components for imaging and image scanning, etc., while CMOS is usually used in low-end video products.

Furthermore, the camera device according to one or more embodiments in the present invention can also be equipped with an external intense light source to play a video through a built-in or external camera. When the projected video is played, the audio can be played with earphones or an external sound system, so that A/V playback function can be implemented.

While the present invention has been illustrated and described with reference to some preferred embodiments, the present invention is not limited to these. Those skilled in the art should recognize that various variations and modifications can be made without departing from the spirit and scope of the present invention as defined by the accompanying claims.

What is claimed is:

1. A camera device, comprising:
a camera lens, adapted to collect image information and magnify image,
an image acquisition unit, adapted to obtain image information through the camera lens,
an image storage unit, adapted to store image information,
an image display unit, adapted to display for projecting images according to the image information stored in the image storage unit or directly from the image acquisition unit,
a light source unit, adapted to provide a light source when the image display unit displays the images,
a switch management unit, adapted to manage the image display unit, the light source and the camera lens to cooperatively operating to projecting the image for showing,
wherein, the images are projected through the camera lens using the light source and the displaying of the image display unit under the managing of the switch management unit.

2. The camera device according to claim 1, further comprising an image processing unit between the image acquisition unit and the image storage unit, the image processing unit being adapted to perform A/D conversion and compressed encoding for the acquired image information.

3. The camera device according to claim 2, wherein the image processing unit further comprises:
an A/D conversion sub-unit, adapted to convert the acquired image information into digital image information;
a compression sub-unit, adapted to perform compressed encoding for the digital image information.

4. The camera device according to claim 1, wherein the image display unit is of transmission type or reflection type.

5. The camera device according to claim 1, wherein the camera lens comprises a Charge Coupled Device (CCD) or Complementary Metal-Oxide-Semiconductor (CMOS).

6. The camera device according to claim 1, wherein the light source is a cold intensive-light source.

7. The camera device according to claim 1, wherein the light source unit comprises a light source and a mirror condenser for collimating and reflecting the light emitted from the light source for providing parallel light.

8. A method for showing images in a camera device, comprising:
obtaining image information via a lens of a camera device;
displaying the image information with illumination of a light source to project images corresponding to the image information through the lens for showing.

9. The method according to claim 8, further comprising performing A/D conversion and compressed encoding for the obtained image information, to store in the camera device.

10. The method according to claim 9, wherein the images are projected in accordance with the directly obtained image information via the lens of the camera device or the image information stored in the camera device.

11. The method according to claim 8, wherein the displaying the image information with illumination of a light source to project images corresponding to the image information through the lens for showing further comprises: magnifying the images through the lens.

12. The method according to claim 11, wherein light emitted from the light source is collimated and illuminated to project images corresponding to the image information.

13. The method according to claim 8, wherein the light source is a cold intensive-light source.

14. A mobile phone, communicated with a network, comprising a camera device, configured to project image information stored, acquired or received from the network for showing.

15. The mobile phone according to claim 14, the camera device further comprising:
a camera lens, adapted to magnify image,
an image display unit, adapted to display for projecting images according to image information,
a light source unit, adapted to provide a light source when the image display unit displays the images,
a switch management unit, adapted to manage the image display unit, the light source and the camera lens to cooperatively operating to projecting the image for showing,
wherein, the images are projected through the camera lens using the light source and the displaying of the image display unit under the managing of the switch management unit.

16. The mobile phone according to claim 14, wherein, the camera lens is further adapted to colleting image information.

17. The camera device according to claim 14, wherein the image display unit is of transmission type or reflection type.

18. The camera device according to claim 14, wherein the camera lens is a Charge Coupled Device or Complementary Metal-Oxide-Semiconductor.

19. The camera device according to claim 14, wherein the light source is a cold intensive-light source.

20. The camera device according to claim 14, wherein the light source unit comprises a light source and a mirror condenser for collimating and reflecting the light emitted from the light source for providing collimated light.
